(19) United States
(12) Patent Application Publication
(10) Pub. No.: US 2020/0390061 A1
(43) Pub. Date: Dec. 17, 2020

(54) WEARABLE VENTED NON-PINCHING PET SHOE DEVICE

(71) Applicant: Natalie Anastakis, Coldwater (CA)

(72) Inventor: Natalie Anastakis, Coldwater (CA)

(21) Appl. No.: 16/896,068

(22) Filed: Jun. 8, 2020

Related U.S. Application Data
(60) Provisional application No. 62/862,285, filed on Jun. 17, 2019.

(51) Int. Cl. A01K 13/00; A43B 23/02

(52) U.S. Cl. CPC A01K 13/007; A43B 23/0245

(57) ABSTRACT

The wearable vented non-pinching pet shoe device disclosed herein is intended to be worn indoors to prevent dogs from slipping on surfaces such as hardwood, laminate, linoleum, and tile. It is breathable, light-weight paw wear with a reinforced toe and nail guard that provides grip allowing dogs to get up with ease and to protect against surface scratches. The device is also ideal as a slip guard for dogs on boats to prevent slipping and allow water to flow through when swimming. The device that may also be worn outdoors to prevent a pet from injuring its paws on rough surfaces, and may also provide the pet with tactile feedback regarding its environment on all surfaces. Some features of the wearable vented non-pinching pet shoe device may include a thermoplastic composition, reusable and pliable materials, vent holes or perforations for breathability, airflow, and water flow, and an adjustable safety strap for easy wearability and comfort.

### TECHNICAL FIELD OF THE INVENTION

The present invention relates in general to pet accessories, and, more specifically, to a wearable vented non-pinching pet shoe device.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

A shoe is a wearable device intended to be worn on the foot or feet of a wearer. Shoes may be designed to protect the feet of the wearer, and may further augment the wearer's ability to perform certain tasks. By way of example, most shoes generally provide a protective layer between the wearer and the surface upon which the wearer is standing or walking. Some shoes, such as steel-toed shoes, may further provide crush-protection to the upper foot and toes of the wearer. Thicker sole shoes may protect a wearer from rougher terrain and sharp-force intrusions into the bottom of the foot, and higher ankle protection may assist a wearer in changing directions rapidly due to the additional ankle support.

Shoes may also be worn as a form of decoration or fashion, and the style of shoes may vary depending on the wearer's intended purpose. High-heeled shoes may be worn, for example, to add height to a wearer or to accent their calves and legs. Dress shoes may be worn to complement the appearance of a suit or other formal wear. Sandals, on the other hand, may be worn to accent dressing in an informal or relaxed manner, and may provide only the most basic protection to a wearer.

Many shoes are designed for a specific purpose. Cowboy boots, for example, are designed to both protect a wearer's lower pants from dirt and other contamination while also allowing a horse rider to properly engage a stirrup. Mountaineering shoes may further incorporate a spiked front component to aid in vertical traction when ascending steep or sheer terrain. Skiing shoes may incorporate a latching system that allows the wearer to attach themselves to skis or a snowboard for proper control.

The wearing of shoes is not limited to human wearers. Horses, for example, may wear horseshoes for additional traction and protection of their hooves. Shoes may also be worn by cats, dogs, and other domesticated animals for aesthetic or functional purposes. Some pet shoes may be designed to protect the animal's paws from dirt and contamination or from injury to the pads of their paws.

Shoes for dogs, in particular, are available in a variety of designs to suit a number of purposes. Some dog shoes are made available in various fabrics and may comprise a mechanism for securing the shoe around the dogs paw or leg. Such shoes may include an insulation layer, and may be designed for keeping the dog's paw warm in colder environments. Other shoes, which may be made of plastics or a combination of fabrics and plastics, may be more rigid than a purely fabric shoe and may be designed specifically for outdoor use. Such shoes may include a traction surface on the bottom of the shoe, similar to as would be seen in a shoe designed for a human, and may further comprise a waterproof material or layer.

The problem with such shoe designs is that, while they way provide environmental protection to the dog's paw, they do not allow the dog to sense its environment through its paws. The tactile feedback that a dog normally receives through its paws is reduced or eliminated by the wearing of closed-bottom shoes. No dog shoes exist that provide a dog with environment protection and traction, while also allowing a dog to receive tactile feedback regarding its environment while wearing the shoe.

Thus, there is a need in the art for a wearable vented non-pinching pet shoe device that may be worn indoors to prevent a pet from slipping on smooth surfaces while remaining light weight and breathable, and allowing the pet to grip surfaces without scratching those surfaces with their claws. The wearable vented non-pinching pet shoe device that may also be worn outdoors to prevent a pet from injuring its paws on rough surfaces, and may also provide the pet with tactile feedback regarding its environment on all surfaces. It is to these ends that the present invention has been developed.

### BRIEF SUMMARY OF THE INVENTION

To minimize the limitations in the prior art, and to minimize other limitations that will be apparent upon reading and understanding the present specification, the present invention describes a wearable vented non-pinching pet shoe device.

It is an objective of the present invention to provide a wearable vented non-pinching pet shoe device that may comprise a wearable device.

It is another objective of the present invention to provide a wearable vented non-pinching pet shoe device that may comprise a plurality of wearable devices.

It is another objective of the present invention to provide a wearable vented non-pinching pet shoe device that may comprise a resilient material of construction.

It is another objective of the present invention to provide a wearable vented non-pinching pet shoe device that may comprise a flexible material of construction.

It is another objective of the present invention to provide a wearable vented non-pinching pet shoe device that may comprise a shoe.

It is another objective of the present invention to provide a wearable vented non-pinching pet shoe device that may comprise a single-component construction.

It is another objective of the present invention to provide a wearable vented non-pinching pet shoe device that may comprise a multi-component construction.

It is another objective of the present invention to provide a wearable vented non-pinching pet shoe device that may comprise a traction device.

It is another objective of the present invention to provide a wearable vented non-pinching pet shoe device that may comprise a reinforced sole.

It is another objective of the present invention to provide a wearable vented non-pinching pet shoe device that may comprise a reinforced toe.

It is another objective of the present invention to provide a wearable vented non-pinching pet shoe device that may comprise a plurality of vent holes.

It is another objective of the present invention to provide a wearable vented non-pinching pet shoe device that may comprise a fastening component.

It is another objective of the present invention to provide a wearable vented non-pinching pet shoe device that may comprise a size-adjustability.

It is another objective of the present invention to provide a wearable vented non-pinching pet shoe device that may comprise a non-pinching design.

It is another objective of the present invention to provide a wearable vented non-pinching pet shoe device that may comprise an antimicrobial layer.

It is another objective of the present invention to provide a wearable vented non-pinching pet shoe device that may comprise an antimicrobial material of construction.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 is a right side perspective view of a first embodiment of a wearable vented non-pinching pet shoe device, as contemplated by the present disclosure;

FIG. 2 is a front perspective view of a first embodiment of a wearable vented non-pinching pet shoe device, as contemplated by the present disclosure;

FIG. 3 is a top perspective view of a first embodiment of a wearable vented non-pinching pet shoe device, as contemplated by the present disclosure;

FIG. 4 is a right side perspective view of a first embodiment of a wearable vented non-pinching pet shoe device, as contemplated by the present disclosure;

FIG. 5 is a cross-sectional view of a first embodiment of a wearable vented non-pinching pet shoe device, as contemplated by the present disclosure;

FIG. 6 is a right side perspective view of a second embodiment of a wearable vented non-pinching pet shoe device, as contemplated by the present disclosure;

FIG. 7 is a front perspective view of a second embodiment of a wearable vented non-pinching pet shoe device, as contemplated by the present disclosure;

FIG. 8 is a top perspective view of a second embodiment of a wearable vented non-pinching pet shoe device, as contemplated by the present disclosure;

FIG. 9 is a cross-sectional view of a second embodiment of a wearable vented non-pinching pet shoe device, as contemplated by the present disclosure;

FIG. 10 is a right side perspective view of a third embodiment of a wearable vented non-pinching pet shoe device, as contemplated by the present disclosure;

FIG. 11 is a front perspective view of a third embodiment of a wearable vented non-pinching pet shoe device, as contemplated by the present disclosure;

FIG. 12 is a top perspective view of a third embodiment of a wearable vented non-pinching pet shoe device, as contemplated by the present disclosure; and

FIG. 13 is a cross-sectional view of a third embodiment of a wearable vented non-pinching pet shoe device, as contemplated by the present disclosure.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The wearable vented non-pinching pet shoe device disclosed herein is intended to be worn indoors to prevent dogs from slipping on surfaces such as hardwood, laminate, linoleum, and tile. It is breathable, light-weight paw wear with a reinforced toe and nail guard that provides grip allowing dogs to get up with ease and to protect against surface scratches. The device is also ideal as a slip guard for dogs on boats to prevent slipping and allow water to flow through when swimming. The device that may also be worn outdoors to prevent a pet from injuring its paws on rough surfaces, and may also provide the pet with tactile feedback regarding its environment on all surfaces. Some features of the wearable vented non-pinching pet shoe device may include a thermoplastic composition, reusable and pliable materials, vent holes or perforations for breathability, airflow, and water flow, and an adjustable safety strap for easy wearability and comfort.

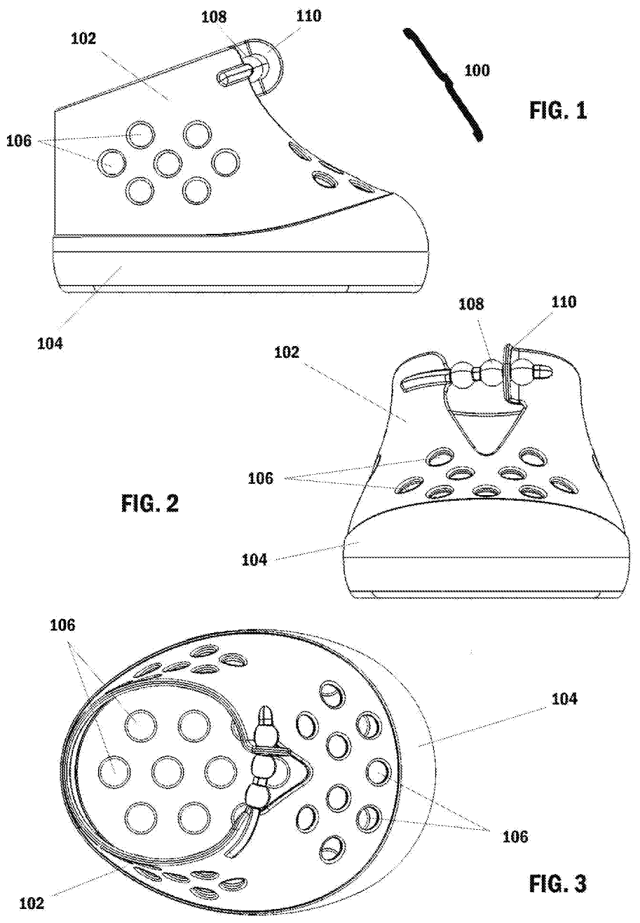

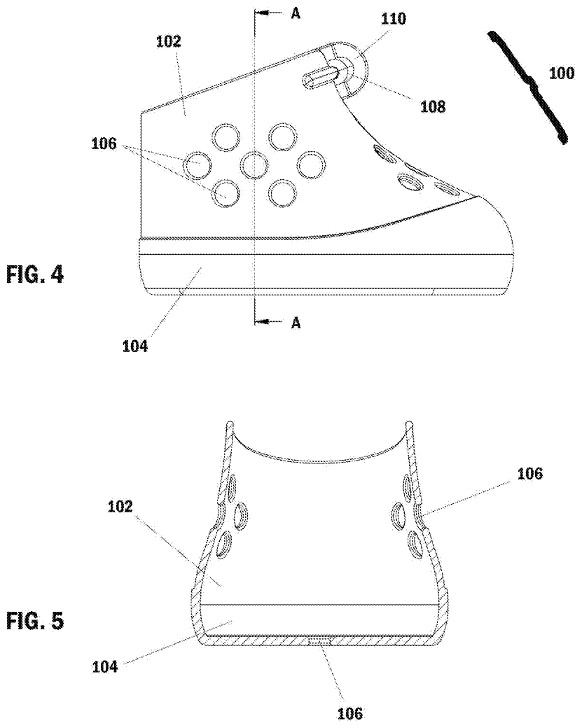

The illustrations of FIGS. 1-5 illustrate a first embodiment of a wearable vented non-pinching pet shoe device, as contemplated by the present disclosure. The device may comprise, generally, a main body 100 having an upper component, which may be an upper body 102, and a lower component, which may be a sole 104.

In a first embodiment the upper body 102 may be designed to wrap around the paw of a pet and may substantially comprise a single sheet of material forming a truncated cone shape. The cone shape may have a substantially vertical rear wall and outwardly flaring side and front walls. The top area of the cone shape may be open, and may comprise an opening substantially suitable to wrap around the ankle or lower leg of an exemplary pet without applying excessive pressure to the ankle or lower leg of the pet. The upper body 102 may comprise a material of construction having a thickness of, for example, between 1 millimeter (mm) and 2 mms, though the thickness may vary as desired.

The sole 104 of the first embodiment may be designed as a lower cap of the upper body 102, and the upper edges of the sole 104 may be contiguous with the lower edges of the upper body 102. In this way the sole 104 completely encloses the lower opening of the upper body 102 and provides a structural base for the device. The sole 104 may further comprise a protective layer between the paw of the pet wearer and a surface upon which it is standing. The sole 104 may comprise a material of construction having a thickness relatively thicker than the upper body 102, which may vary from, for example, 1.5 mms to 2.5 mms, though the thickness may vary as desired.

The sole 104 of the first embodiment may substantially comprise a complete base for the wearable vented non-pinching pet shoe device inasmuch as the device is completely supported by the sole 104 around the perimeter of the pet wearer's paw. The sole 104 may further comprise a front section, lateral side sections, and a rear section, which attach to, relatively, the front, side, and rear walls of the upper body 102.

The upper body 102 and the sole 104 of the first embodiment may further comprise a plurality of holes 106 that may be arranged, as desired for functional or aesthetic purposes, throughout the upper body 102 and sole 104. The plurality of holes 106 may be arranged such that they provide air and fluid ventilation throughout the wearable vented non-pinching pet shoe device so that the pet wearer's paw is not contained within a closed environment while the device is being worn. The sole 104 may further comprise a plurality of holes 106 that permit the pet wearer to touch the surface upon which they are standing, so as to provide tactile feedback to the pet wearer for their comfort and security. The proximity of the plurality of holes 106 to one another may be such that the structural integrity of the upper body 102 and the sole 104 is maintained.

The upper body 102 of the first embodiment may further comprise a notched opening 112 in an upper area of its front wall and a means for attachment such that the front wall may be laterally expanded or contracted for sizing adjustability. The means for attachment may comprise, for example, and adjustable strap 108 and a strap receiver 110 combination. The adjustable strap 108 may be any strap appropriate to the adjustment of the wearable vented non-pinching pet shoe device, and the strap receiver 110 may be any strap receiver appropriate to the adjustable strap 108 selected.

By way of an example, the adjustable strap 108 of the first embodiment may be a flexible strap having relatively larger protrusions at regular intervals along its length. The strap receiver 110, then, may be designed to allow such protrusions to pass through a larger opening in the strap receiver 110 and then have the adjustable strap 108 notched into a relatively smaller opening in the strap receiver 110. In this way the adjustable strap 108 may be adjusted, as desired, and then held by the strap receiver 110 to maintain the selected sizing of the upper body 102. The protrusions on the strap 108 may have a substantially flattened inner surface so as not to pinch the ankle or lower leg of the pet wearer.

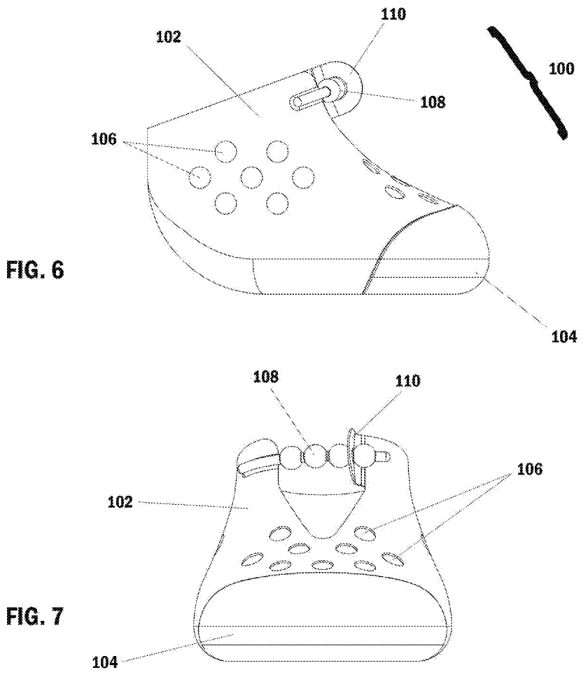

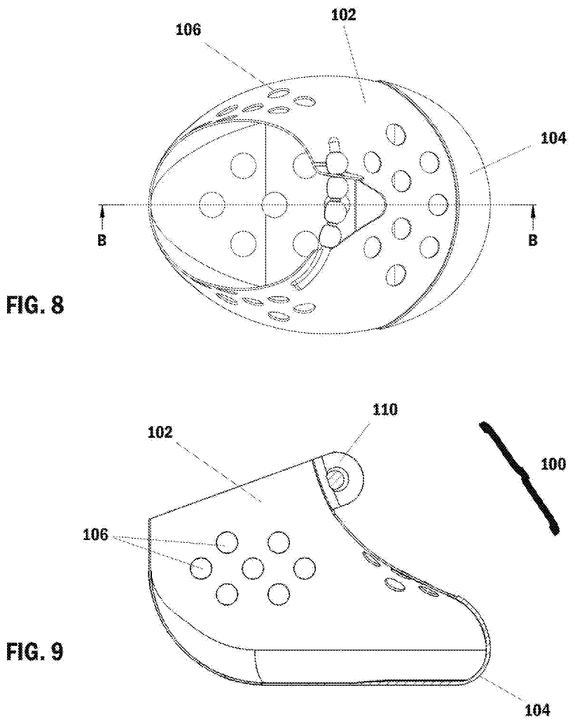

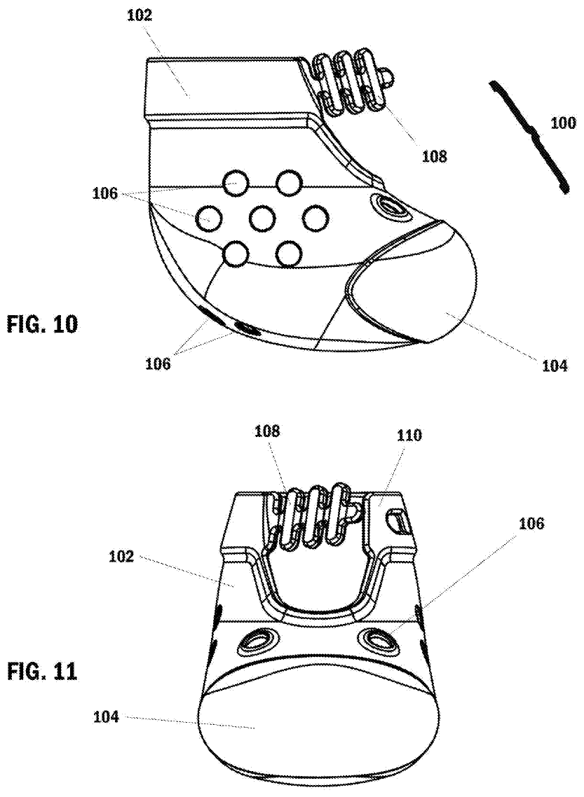

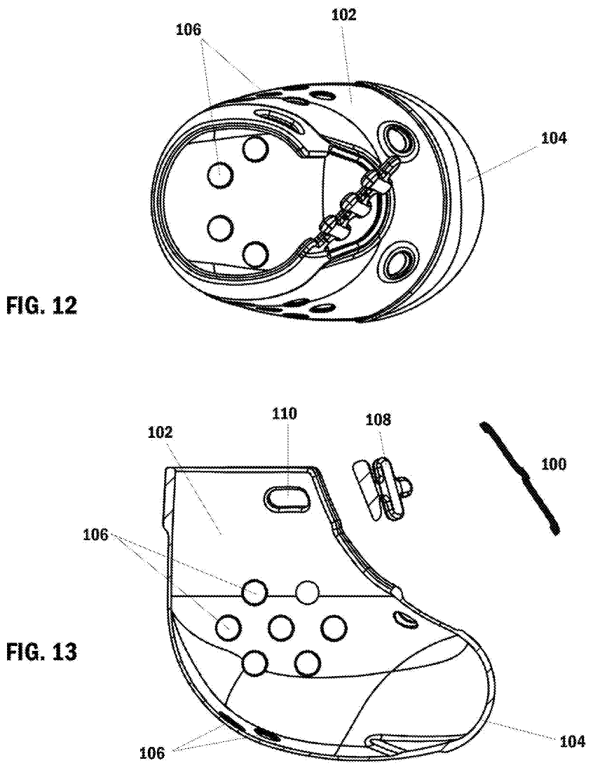

The illustrations of FIGS. 6-11 illustrate a second and third embodiment of a wearable vented non-pinching pet shoe device, as contemplated by the present disclosure. In a second and third embodiment the upper body 102 may be designed to wrap around the paw of a pet and may substantially comprise a single sheet of material forming a truncated cone shape. The cone shape may have a substantially vertical rear wall and outwardly flaring side and front walls, and the various walls may come together under the bottom of the device to form a partial base. The top area of the cone shape may be open, and may comprise an opening substantially suitable to wrap around the ankle or lower leg of an exemplary pet without applying excessive pressure to the ankle or lower leg of the pet. The upper body 102 may comprise a material of construction having a thickness of, for example, between 1 mm and 2 mms, though the thickness may vary as desired.

The sole 104 of the second and third embodiment may be designed as a front cap of the upper body 102, and the upper and trailing edges of the sole 104 may be contiguous with the leading edges of the upper body 102. In this way the sole 104 completely encloses the front opening of the upper body 102 and provides, in combination with the lower portion of the walls of the upper body 102, a structural base for the device. The sole 104 may further comprise a protective layer between the paw of the pet wearer and a surface upon which it is standing. The sole 104 may comprise a material of construction having a thickness relatively thicker than the upper body 102, which may vary from, for example, 1.5 mms to 2.5 mms, though the thickness may vary as desired.

The sole 104 of the second embodiment may substantially comprise a partial base for the wearable vented non-pinching pet shoe device inasmuch as the device is only partially supported by the sole 104 around the toes or claws of the pet wearer's paw. The sole 104 may further comprise a top section, lateral side sections, and a bottom section, which attach to, relatively, the front, side, and rear walls of the upper body 102.

The upper body 102 and the sole 104 of the second embodiment may further comprise a plurality of holes 106 that may be arranged, as desired for functional or aesthetic purposes, throughout the upper body 102 and sole 104. The plurality of holes 106 may be arranged such that they provide air and fluid ventilation throughout the wearable vented non-pinching pet shoe device so that the pet wearer's paw is not contained within a closed environment while the device is being worn. The sole 104 may further comprise a plurality of holes 106 that permit the pet wearer to touch the surface upon which they are standing, so as to provide tactile feedback to the pet wearer for their comfort and security. The proximity of the plurality of holes 106 to one another may be such that the structural integrity of the upper body 102 and the sole 104 is maintained.

The upper body 102 of the second and third embodiment may further comprise a notched opening 112 in an upper area of its front wall and a means for attachment such that the front wall may be laterally expanded or contracted for sizing adjustability. The means for attachment may comprise, for example, and adjustable strap 108 and a strap receiver 110 combination. The adjustable strap 108 may be any strap appropriate to the adjustment of the wearable vented non-pinching pet shoe device, and the strap receiver 110 may be any strap receiver appropriate to the adjustable strap 108 selected.

By way of an example, the adjustable strap 108 of the second and third embodiment may be a flexible strap having relatively larger protrusions at regular intervals along its length. The strap receiver 110, then, may be designed to allow such protrusions to pass through a larger opening in the strap receiver 110 and then have the adjustable strap 108 notched into a relatively smaller opening in the strap receiver 110. In this way the adjustable strap 108 may be adjusted, as desired, and then held by the strap receiver 110 to maintain the selected sizing of the upper body 102. The protrusions on the strap 108 may have a substantially flattened inner surface so as not to pinch the ankle or lower leg of the pet wearer.

In any embodiment the wearable vented non-pinching pet shoe device may comprise a handed design inasmuch as a single shoe may represent a left shoe or a right shoe. In such an embodiment the device may further comprise a reversible design so that a left shoe may be inverted into a right shoe, and vice-versa, without affecting the function of the selected embodiment.

In any embodiment the wearable vented non-pinching pet shoe device may comprise a breakaway design inasmuch as the adjustable strap 108 engaged in the strap receiver 110 may release if a pre-determined pressure is exceeded. The adjustable strap 108 may release from the strap receiver 110 itself, or may actually separate from the upper body 102, as appropriate. By such a design the device may be intended to release from a dog's paw if excessive pressure is placed on the dog's paw to prevent the dog from becoming stuck within the device. If, for example, the dog is traversing terrain and the device becomes stuck under a rock, the dog may be able to break free from the device so that it is not, also, stuck.

The wearable vented non-pinching pet shoe device may be substantially constructed of any suitable material or combination of materials, but typically is constructed of a resilient material or combination of materials such that the device is resistant to damage as a result of compression, twisting, heating, or submersion in water. As an example, and without limiting the scope of the present invention, various exemplary embodiments of the wearable vented non-pinching pet shoe device may be substantially constructed of one or more materials of silicone, rubber, latex, foam, thermoplastics, polymers, elastomers, fabric, acrylic, polycarbonate, steel, aluminum, brass, fiberglass, carbon fiber, or combinations thereof. In some embodiments the various components of the device may be coated, lined, or otherwise insulated to prevent contamination of the device. In one embodiment the material of construction may vary from one component to the next within the system.

In one embodiment the wearable vented non-pinching pet shoe device may comprise a resilient material of construction that either comprises a material having antimicrobial properties or comprises a layering of antimicrobial material or coating. Antimicrobial properties comprise the characteristic of being antibacterial, biocidal, microbicidal, anti-fungal, anti-viral, or other similar characteristics, and the oligodynamic effect, which is possessed by copper, brass, silver, gold, and several other metals and alloys, is one such characteristic. Copper and its alloys, in particular, have exceptional self-sanitizing effects. Silver also has this effect, and is less toxic to users than copper. Some materials, such as silver in its metallic form, may require the presence of moisture to activate the antimicrobial properties.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. A wearable vented non-pinching pet shoe device, comprising:
a main body;
an upper body;
a sole;
a plurality of ventilation holes; and
a plurality of tactile holes;
wherein said main body comprises said upper body and said sole;
wherein said upper body comprises a shape suitable for partially covering a dog's paw;
wherein said upper body comprises an open bottom surface and a lower edge;
wherein said sole comprises a shape suitable for partially covering a dog's paw complementary to said upper body;
wherein said sole comprises an upper edge; and
wherein said lower edge of said upper body is attached to said upper edge of said sole.

2. The invention of claim 1, wherein said upper body further comprises a thickness;
wherein said sole further comprises a thickness;
wherein said plurality of ventilation holes comprise a plurality of openings through said thickness of said upper body;
wherein said plurality of tactile holes comprise a plurality of openings through said thickness of said sole; and
wherein said thickness of said sole is relatively thicker than said thickness of said upper body.

3. The invention of claim 2,
wherein said upper body further comprises a notched opening; and
wherein said notched opening allows said upper body to be flexed for ease of wearing and removing the pet shoe device.

4. The invention of claim 3, further comprising:
a closure mechanism;
wherein said closure mechanism attaches across said notched opening of said upper body; and
wherein said closure mechanism limits said upper body from flexing to prevent removing the pet shoe device.

5. The invention of claim 4, further comprising:
a reversible design.

6. The invention of claim 4, further comprising:
a non-pinching design.

7. The invention of claim 4, further comprising:
a breakaway design.

8. The invention of claim 4, further comprising:
a thermoplastic material of construction.

9. A wearable vented non-pinching pet shoe device, comprising:
a main body;
an upper body;
a sole;
a plurality of ventilation holes; and
a plurality of tactile holes;
wherein said main body comprises said upper body and said sole;
wherein said upper body comprises a shape suitable for partially covering a dog's paw;
wherein said upper body comprises a partial bottom surface and a front edge;
wherein said sole comprises a shape suitable for partially covering a dog's paw complementary to said upper body;
wherein said sole comprises a rear edge; and
wherein said front edge of said upper body is attached to said rear edge of said sole.

10. The invention of claim 9,
wherein said upper body further comprises a thickness;
wherein said sole further comprises a thickness;
wherein said plurality of ventilation holes comprise a plurality of openings through said thickness of said upper body;
wherein said plurality of tactile holes comprise a plurality of openings through said thickness of said upper body; and
wherein said thickness of said sole is relatively thicker than said thickness of said upper body.

11. The invention of claim 10,
wherein said upper body further comprises a notched opening; and
wherein said notched opening allows said upper body to be flexed for ease of wearing and removing the pet shoe device.

12. The invention of claim 11, further comprising:
a closure mechanism;
wherein said closure mechanism attaches across said notched opening of said upper body; and
wherein said closure mechanism limits said upper body from flexing to prevent removing the pet shoe device.

13. The invention of claim 12, further comprising:
a reversible design.

14. The invention of claim 12, further comprising:
a non-pinching design.

15. The invention of claim 12, further comprising:
a breakaway design.

16. The invention of claim 12, further comprising:
a thermoplastic material of construction.

17. A wearable vented non-pinching pet shoe device, comprising:
a main body;
a plurality of ventilation holes; and
a plurality of tactile holes;
wherein said main body further comprises an upper cover, a toe cover, and a lower cover;
wherein said upper cover further comprises a lower edge and a front edge;
wherein said toe cover further comprises an upper rear edge and a lower rear edge;
wherein said lower cover further comprises an upper edge and a front edge
wherein said lower edge of said upper cover is attached to said upper edge of said lower cover;
wherein said front edge of said upper cover is attached to said upper rear edge of said toe cover;
wherein said front edge of said lower cover is attached to said lower rear edge of said toe cover;
wherein said upper cover further comprises a thickness;
wherein said toe cover further comprises a thickness;
wherein said lower cover further comprises a thickness;
wherein said plurality of ventilation holes comprise a plurality of openings through said thickness of said upper cover; and
wherein said plurality of tactile holes comprise a plurality of openings through said thickness of said lower cover.

18. The invention of claim 17, further comprising:
a closure mechanism;
wherein said upper cover further comprises a notched opening;
wherein said notched opening allows said upper body to be flexed for ease of wearing and removing the pet shoe device
wherein said closure mechanism attaches across said notched opening of said upper cover; and
wherein said closure mechanism limits said upper cover from flexing to prevent removing the pet shoe device.

19. The invention of claim 18,
wherein said thickness of said toe cover is relatively thicker than said thickness of said upper cover and said lower cover.

20. The invention of claim 18,
wherein said thickness of said toe cover is equal to said thickness of said lower cover and relatively thicker than said thickness of said upper cover.
